(19) United States
(12) Patent Application Publication
(10) Pub. No.: US 2011/0299359 A1
(43) Pub. Date: Dec. 8, 2011

(54) DISTRIBUTIVE AND DISPERSIVE MIXING APPARATUS OF THE CDDM TYPE, AND ITS USE

(76) Inventors: Christopher John Brown, Derbyshire (GB); Graeme Neil Irving, Wirral (GB); Adam Jan Kowalski, Wirral (GB)

(21) Appl. No.: 13/146,649

(22) PCT Filed: Feb. 3, 2010
(86) PCT No.: PCT/EP2010/051292

§ 371 Date: Aug. 25, 2011

(30) Foreign Application Priority Data
Feb. 9, 2009 (GB) 0901956.3

(51) Int. Cl. B01F 7/02; B01F 3/08

(52) U.S. Cl. 366/292; 366/302

(57) ABSTRACT

A distributive and dispersive mixing apparatus of the CDDM type comprising two confronting surfaces as being the inner surface of shell (4) and the outer surface of fixed cage (2)) and at least one cage-like member (3) disposed between the confronting surfaces said cage-like member (3) defining passages for fluid flow adjacent at least one of the confronting surfaces CHARACTERISED IN THAT the or at least one cage-like member (3) has a relative rotational movement but is not freely rotating relative to at least one of the confronting surfaces and/or at least one other cage-like member, and the bulk fluid flow within the mixing apparatus is in the plane of the surface of the or at least one cage-like member perpendicular to the direction of relative rotational movement.

### TECHNICAL FIELD

The present invention relates to mixing apparatus for fluids and in particular, to flexible mixing devices which can provide a range of mixing conditions.

### BACKGROUND OF THE INVENTION

It is recognised that mixing can be described as either distributive or dispersive. In a multi-phase material comprising discrete domains of each phase, distributive mixing seeks to change the relative spatial positions of the domains of each phase, whereas dispersive mixing seeks to overcome cohesive forces to alter the size and size distribution of the domains of each phase. Most mixers employ a combination of distributive or dispersive mixing although, depending on the intended application the balance will alter. For example a machine for mixing peanuts and raisins will be wholly distributive so as not to damage the things being mixed, whereas a blender/homogeniser will be dispersive.

Many different types of rotor/stator mixer are known. Stirring reactors such as those disclosed in US 2003/0139543 comprise a vessel with internally mounted mixing elements and are generally distributive in function. Other types of rotor-stator mixer (such as that disclosed in WO 2007/105323 are designed with the intention of forming fine emulsions and are dispersive in character. DE 1557171 discloses a mixer with a plurality of alternately rotating and static, concentric cage-like elements through which the flow is radial.

EP 0799303 and GB 2118058 describes a known mixer type, hereinafter referred to as a “Cavity Transfer Mixer” (CTM), comprising confronting surfaces, each having a series of cavities formed therein in which the surfaces move relatively to each other and in which a liquid material is passed between the surfaces and flows along a pathway successively passing through the cavities in each surface. The cavities are arranged on the relevant surfaces such that shear is applied to the liquid as it flows between the surfaces. In a typical embodiment the mixer comprises an outer sleeve and a close-fitting inner drum. The confronting surfaces of the sleeve and the drum are both provided with cavities disposed so that the cavities overlap forming sinuous and changing flow paths which change as the drum and the sleeve rotate relative to each other. This type of mixer has stator and rotor elements with opposed cavities which, as the mixer operates, move past each other across the direction of bulk flow through the mixer. In such mixers, primarily distributive mixing is obtained. Shear is applied by the relative movement of the surfaces in a generally perpendicular direction to the flow of material. In the typical embodiment described above, this is accomplished by relative rotation of the drum and the sleeve. In such a device there is relatively little variation in the cross-sectional area for flow as the material passes axially down the device. Generally, the cross-sectional area for flow varies by a factor of less than 3 through the apparatus.

The commercial application of CTMs has been largely restricted to the thermoplastics' conversion industry, where CTM technology originated (see EP 048590). In part this is because established rotor/stator devices, such as “Silverson” mixers, offer some of the benefits and at a significantly lower cost.

In some mixers, such as that described in EP 0434124 a cage-like rotor and stator elements are configured such that the bulk flow must pass through relatively narrow spaces within the reactor. Similar alternation of relatively wide and relatively narrow flow spaces, for the purpose of forming an emulsion, are known from GB 129757. However GB 1297757 and EP 0434124 are not CTM's as the relatively wide spaces form annuli and there it little or no alteration of the flow path geometry as the rotor and stator move.

EP 0799303 also describes a novel mixer, hereinafter referred to as a “Controlled Deformation Dynamic Mixer” (CDDM). In common with the CTM, type of mixer has stator and rotor elements with opposed cavities which, as the mixer operates, move past each other across the direction of bulk flow through the mixer. It is distinguished from the CTM in that material is also subjected to extensional deformation. The extensional flow and efficient dispersive mixing is secured by having confronting surfaces with cavities arranged such that the cross sectional area for bulk flow of the liquid through the mixer successively increases and decreases by a factor of at least 5 through the apparatus. In comparison with the embodiment of the CTM described above, the cavities of the CDDM are generally aligned or slightly offset in an axial direction such that material flowing axially along the confronting surfaces is forced through narrow gaps as well as flowing along and between the cavities. The CDDM combines the distributive mixing performance of the CTM with dispersive mixing performance. Thus, the CDDM is better suited to problems such as reducing the droplet size of an emulsion, where dispersive mixing is essential.

GB 2308076 shows several embodiments of a mixer comprising a co-called “sliding vane” pump. These include both drum/sleeve types where the bulk flow is along the axis of the mixer and mixers in which the flow is radial. Many other types of reactor can be configured either as the drum/sleeve type or the “flat” type. For example DD207104 and GB 2108407 show a mixer comprising two movable confronting surfaces with projecting pins which cause mixing in material flowing in a radial direction between the plates.

Both the CTM and the CDDM can be embodied in a “flat” form where the drum and the sleeve are replaced with a pair of disks mounted for relative rotation and the cavities are provided in the confronting surfaces of the disks. In this modified “flat” form the bulk flow is generally radial.

Despite these advances, there is a need to:
(i) improve dispersive and distributive mixing without recourse to excessive increases in operating pressure and rotational speed;
(ii) be more flexible through interchangeable parts specified according to application;
(iii) increase hygienic security through greater assuredness that the material being processed cannot stagnate within the device; and
(iv) facilitate deployment and maintenance through mechanical simplification.

An important further consideration in certain CDDM designs concerns the relative axial positions of rotor and stator components during operation which are critical to performance. Such relative positions may change by axial displacement of the rotating parts with respect to the static parts and this may compromise critical clearances. Under “normal” operating conditions, such displacement is resisted through thrust bearings, an approach which becomes more difficult at high pressures and mixer speeds.

There are practical limits to the spacing between the confronting surfaces in the CDDM and CTM. As the device is heated, expansion may mean that the rotor/drum expands in a radial direction. The stator/sleeve may expand less as it is better able to lose heat. This can result in a narrowing of the gap between the confronting surfaces and even contact. At high operating speeds, contact between the surfaces can be catastrophic.

### BRIEF DESCRIPTION OF THE INVENTION

We have determined that the CTM/CDDM type mixer can be significantly improved by providing at least one cage-like member between the confronting surfaces, provided that the cage-like member is not freely rotating.

According to a first aspect of the present invention there is provided a distributive and dispersive mixing apparatus of the CDDM type comprising two confronting surfaces and at least one cage-like member disposed between the confronting surfaces said cage-like member defining passages for fluid flow adjacent at least one of the confronting surfaces CHARACTERISED IN THAT the or at least one cage-like member has a relative rotational movement but is not freely rotating relative to at least one of the confronting surfaces and/or at least one other cage-like member, and the bulk fluid flow within the mixing apparatus is in the plane of the surface of the or at least one cage-like member perpendicular to the direction of relative rotational movement.

By “cage-like” is meant a member having apertures which allow fluid flow from a first surface of the member to a second surface of the cage-like member. In the sleeve/drum form of the CTM/CDDM this can comprise a tube-shaped element having ports communicating between the inside and the outside.

By providing such a cage-like member (or more than one such member) between the confronting surfaces it is possible to improve both dispersive and distributive mixing. This occurs due to the significant increase in the exposure of the process fluid to regions of high shear and extensional flow, and is obtained without increased operating speeds or pressure drops.

By “not freely rotating relative to at least one of the confronting surfaces or at least one other cage-like member” is meant that the, or at least one, cage-like member is not simply a freely moving element being dragged around by the dynamics of the fluid flow within the mixer in an uncontrolled manner. It is preferred that the cage-like member motion, relative to at least one of the confronting surfaces is actively driven by a motor.

The invention is described and presented in terms of rotary motion. For the purposes of interpretation of this specification and the intended meaning and scope of its claims, the phrase “but is not freely rotating” should be interpreted to include “oscillates but is not freely oscillating” as the rotary motion need be neither continuous nor unidirectional.

A further aspect of the present invention subsists in the use of the mixing apparatus of the present invention for the treatment of a liquid, emulsion, gel or other flowable composition.

### DETAILED DESCRIPTION OF THE INVENTION

For the purposes of understanding the operation of the CTM or CDDM in general, the disclosure of EP 0799303 is incorporated herein by reference. As noted above, the apparatus of the present invention is similar to the CTM and CDDM in that it comprises two confronting surfaces and the flow path for liquid along these confronting surfaces through the mixer varies in width. Regions of distributive mixing (where the flow path is wide) comprises CTM-like cavities moving across each other in a direction perpendicular to the bulk flow of liquid. Between these regions of distributive mixing are regions in which the flow path is narrower and the flow is more extensional.

In particular embodiments of the present invention at least one of the at least two confronting surfaces is smooth. The provision of a smooth surface adjacent a cage-like member ensures good dispersive mixing. The provision of a smooth confronting surface in a drum/sleeve type of CTM, where the smooth surface is the inner surface of the sleeve is particularly beneficial as it avoids the machining difficulties of providing cavities in the inner surface of the sleeve. One excluded configuration is that in which there is a single cage-like element and both of the confronting surfaces are smooth, as this would contain no CTM-like regions. If both confronting surfaces are smooth then the mixer needs to comprise at least two cage-like elements to that CTM-like mixing across the direction of bulk flow can be achieved.

In particular embodiments of the present invention at least one of the confronting surfaces is provided with cavities, which cavities may be machined into said surface or be formed by a smooth surface and an adjoining member defining apertures and secured thereto. The provision of cavities in the surface adjacent a cage-like member ensures good distributive mixing especially when the respective positions of cavities and apertures are CTM-like. The provision of cavities in the surface adjacent a cage-like member ensures further dispersive mixing when the overlap between cavities and apertures is CDDM-like.

In particular embodiments of the present invention the apparatus comprises either one or more of said cage-like members. Where two or more cage-like members are present they are typically arranged such that a surface of a first member is adjacent or adjoins a surface of a second member.

The apertures on at least one pair of such adjacent or adjoining surfaces within the mixer are in one series of embodiments aligned to enhance the extensional component of flow to which the fluid is subjected. In a drum/sleeve configuration this can be done by ensuring that the apertures on adjacent surfaces are generally aligned or slightly offset in the axial direction. Axial flow from aperture to aperture therefore requires the process fluid to pass through narrow spaces as in the CDDM and good dispersive mixing is obtained.

It is possible for a mixer according to the invention to be provided with one on more regions in which the juxtaposition is such that the arrangement is CTM-like and one or more regions in which the arrangement is CDDM-like.

It is possible to envisage a mixing apparatus according to the present invention in which both of the confronting surfaces are fixed and at least one cage-like member is rotated. In the alternative, the confronting surfaces are rotated relative to each other.

As with the CTM and the CDDM there are several possible configurations for the mixing apparatus. In one preferred combination the confronting surfaces are cylindrical and the, or each, cage-like member is generally tubular. In such a configuration the apparatus will generally comprise a cylindrical drum and co-axial sleeve with one or more cage-like members disposed between them co-axially. The confronting surfaces will be defined by the outer surface of the drum and the inner surface of the sleeve. However, there are alternative configurations in which the confronting surfaces are circular and the, or each, cage-like member is generally disk-shaped. In this disk configuration the, or each, cage-like member will form the “filling” sandwiched between the two confronting surfaces. Between these two extremes of configuration are those in which the confronting surfaces are conical or frusto-conical and the, or each, cage-like member is generally conical or frusto-conical. Non-cylindrical embodiments allow for further variation in the shear in different parts of the flow through the mixer.

In one particularly preferred embodiment of the invention the apparatus comprises surfaces which may be “stepped” on all or some adjacent surfaces.

For example, consider a cylindrical apparatus comprising a “stepped” drum comprising a sequence of two or more cylindrical regions of differing diameters. The sleeve is similarly stepped, so as to maintain the separation between the outer surface of the drum and the inner surface of the sleeve and to define an annular space between them of varying radius. In one such configuration a region of significant axial bulk flow is either followed or preceded by a region of significant radial bulk flow. Advantageously, the axial thrust on the cage will be counteracted by the fluid pressure within the region of radial bulk flow. Similar benefits are obtained with the conical configuration discussed above. A particular advantage of the stepped configuration is that the axial confronting surfaces can be spaced more widely than the radial confronting surfaces. This minimises the problems of thermal expansion, as the spacing between the radial confronting surfaces, where the extensional flow is highest, can be modified by longitudinal displacement of the, or each, cage-like member and/or the drum and/or the sleeve relative to each other.

The steps may be provided on one of the drum and the sleeve, or on both. In the case of the steps being provided on only one of the drum and the sleeve then the cage-like member will be adapted to have a stepped surface on one side (either inside or outside depending on whether the steps are provided on the drum or sleeve respectively) and a surface on the other side which conforms closely to the non-stepped surface. A more preferred arrangement is that corresponding steps are provided on both the sleeve and the drum.

By varying the normal separation of the confronting surfaces in CTM/CDDM type mixers, it is possible to confine the most intense shear to relatively few regions.

The regions where the confronting surfaces (or where one of the surfaces and a surface of the cage like member) are most closely spaced are those where the shear rate within the mixer tends to be the highest. As noted above high shear contributes to power consumption and heating. This is especially true where the confronting surfaces of the mixer are spaced by a gap of less than around 50 microns. Advantageously, confining the regions of high shear to relatively short regions means that the power consumption and the heating effect can be reduced, especially where in the CTM-like regions the confronting surfaces are spaced apart relatively widely. A further benefit of this variation in the normal separation of the confronting surfaces in the direction of bulk flow, is that by having relatively small regions of high shear, especially with a low residence time is that the pressure drop along the mixer can be reduced without a compromise in mixing performance. We have determined that by machining back the confronting surfaces in the CTM-like regions such that the clearance between the confronting surfaces is at least 2 times that of the closer regions, preferably 3-10 times that of the closer regions a very significant power requirement reduction and reduction in operating pressure are obtained.

Additional features of the known CTM and CDDM may be incorporated in the mixer described herein. For example, one or both of the confronting surfaces may be provided with means to heat or cool it. Where cavities are provided in the confronting surfaces these (and also the apertures in the cage-like member) may have a different geometry in different parts of the mixer to as to further vary the shear conditions.

In order that the present invention can be better understood it will be described by way of example and with reference to the accompanying figures, in which:

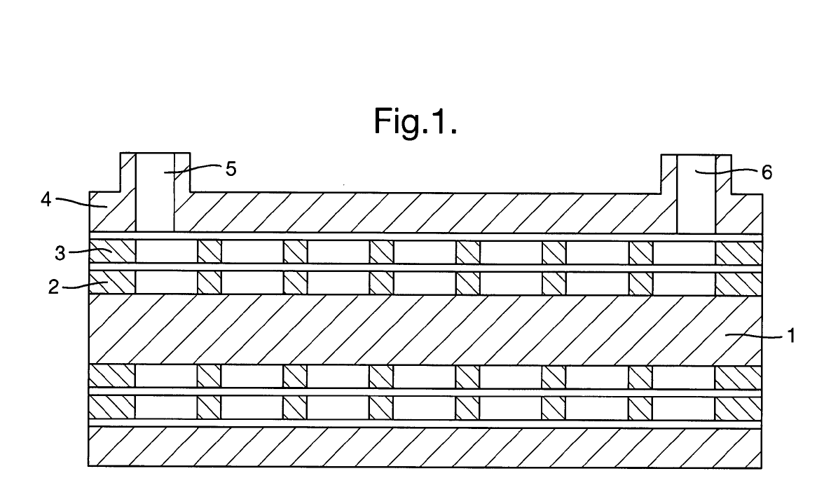

FIG. 1: shows a mixer with a fixed drum, inner cage and sleeve, rotating outer cage;

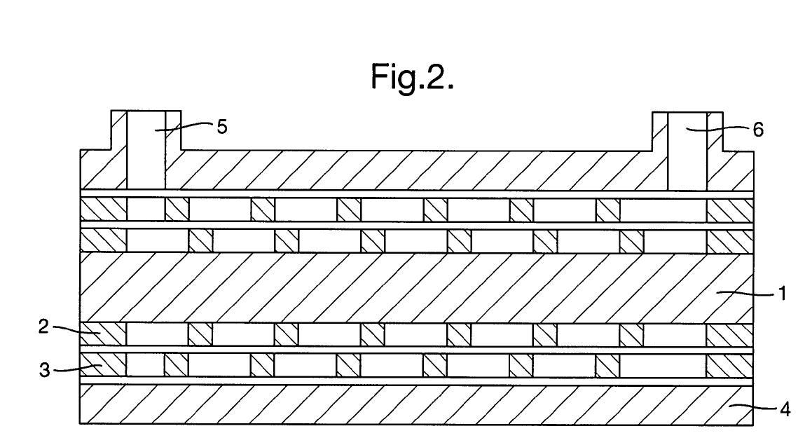

FIG. 2: shows a mixer with a fixed sleeve and inner cage, rotating drum and outer cage;

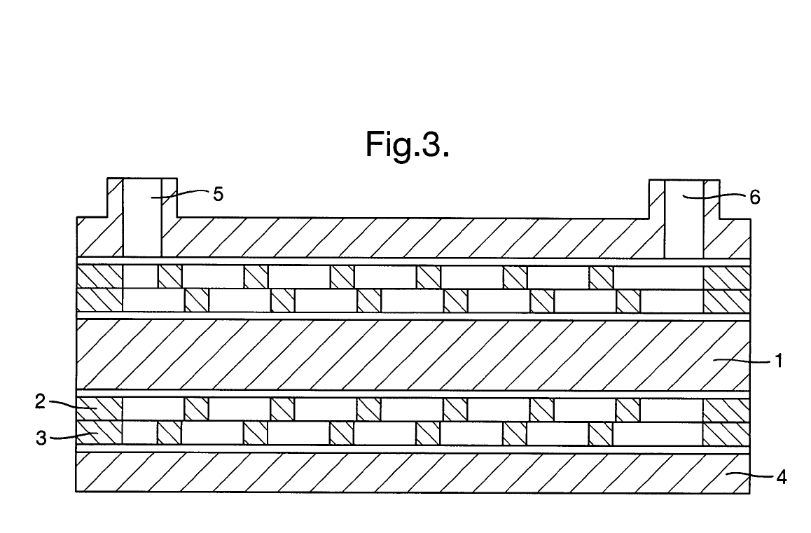

FIG. 3: shows a mixer with a fixed drum and sleeve, rotating inner cage and outer cage (FIG. 3 is not an embodiment of the invention);

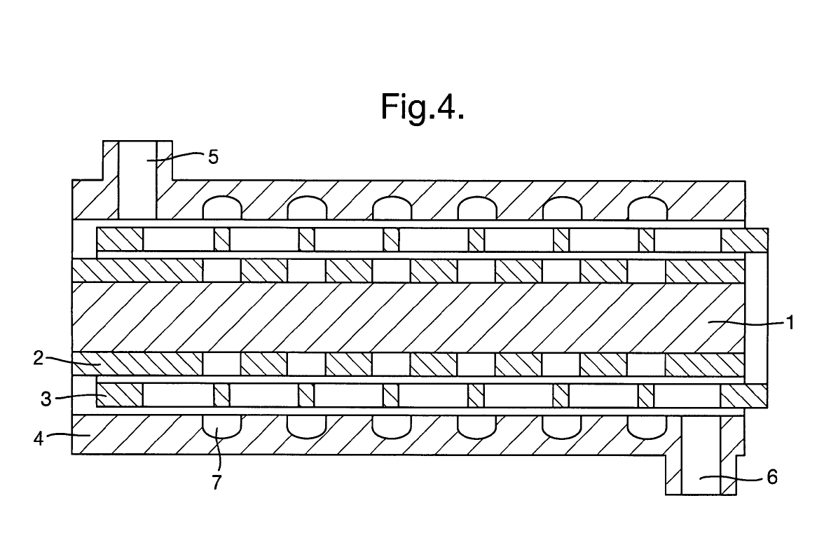

FIG. 4: shows a mixer with a fixed drum, inner cage and sleeve, rotating outer cage;

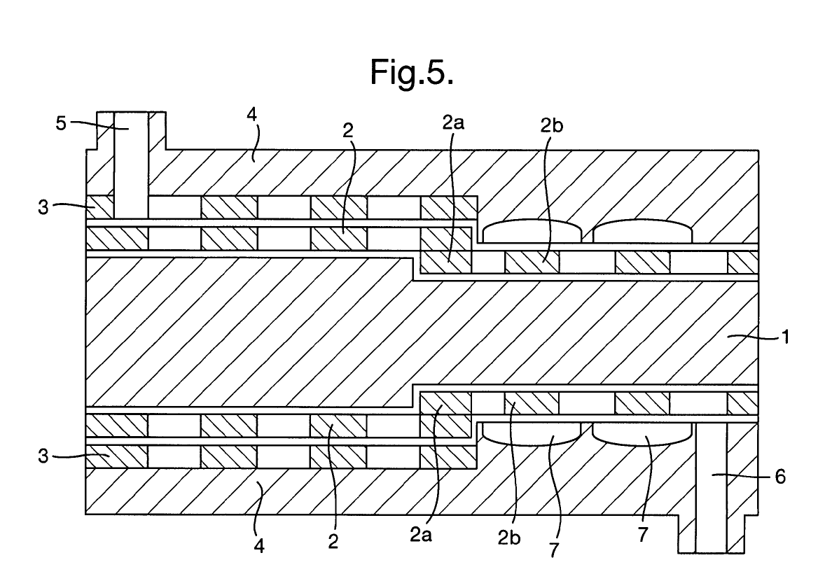

FIG. 5: shows a mixer with a fixed inner stepped drum and outer stepped sleeve, fixed outer cage, rotating inner stepped cage.

### EXAMPLES

In each of the illustrative examples the apparatus comprises an inner drum (1) and an outer sleeve (4). In all the cases illustrated there are two cage-like members (2), (3) present. These are arranged in a concentric and co-axial manner between the drum (1) and the sleeve (4). In the first example the inner cage (2) is fixed to the drum (1) to define cavities in the innermost pair of confronting surfaces. In the fifth example the outer cage (3) is fixed to the sleeve (4) to define cavities in the outer confronting surface. In examples 2 and 3, neither of the cages is fixed to the drum or sleeve. Examples 2 and 3 differ in that the cages are in the one case adjoining and fixed together and in the other case adjacent and movable separately. Example 5 shows a “stepped” configuration. FIG. 3 is not an embodiment of the claimed invention as there is no CTM-like region present, that is no region in which cavities are moving relative to each other across the direction of bulk flow through the mixer.

None of the figures show the end caps of the mixer or the means for driving the moving elements as the figures are intended to be schematic rather than providing full details and dimensions. In the figures, ports (5) and (6) are provided for ingress and egress of the process stream. In embodiments of the invention a plurality of ports may be provided for the ingress of different materials that are to be mixed.

### Example 1

### Fixed Drum, Inner Cage and Sleeve, Rotating Outer Cage

FIG. 1 shows a three part assembly comprising an inner drum (1) to which an inner cage-like member (2) is attached to form a single part. In the alternative the inner drum may be provided with cavities in its outer surface. Outer cage (3) is mounted for rotation around the inner drum/cage. Sleeve (4) has a plain bore. All parts are dimensioned and assembled to be concentric. Ports (5) and (6) are provided for ingress and egress of the process stream.

In use, parts (1), (2) and (4) remain static, and outer cage (3) rotates. A device of the CDDM type is formed across the annulus enclosed between fixed inner cage (2) and moving outer cage (3). During rotation of the outer cage (3) relative to inner cage-like member (2) and drum (1) material flows between the apertures in cage (3) and the cavities defined by cage-like member (2) and drum (1) and as the cages are rotating relative to each other there is a constant “chopping” of the process stream across the direction of bulk flow through the mixer. Further mixing occurs as a consequence of flow through the annulus formed between outer cage (3) and sleeve (4). This further mixing is a continuous dispersive mixing operation due to the relative movement of the outer cage (3) and sleeve (4) in the regions of low radial separation and high shear between the cage (3) and sleeve (4).

A particular advantage of this configuration is that the inner surface of the sleeve (4) only needs to be machined flat and does not have to be provided with cavities.

### Example 2

### Fixed Sleeve and Inner Cage, Rotating Drum and Outer Cage

FIG. 2 shows a four part assembly comprising an inner drum (1) with a plain surface, inner cage (2), outer cage (3) and outer sleeve (4) with a plain bore. The four parts are dimensioned and assembled to be concentric with respect to each other. In use, cage (2) and sleeve (4) remain static, and drum (1) and cage (3) rotate. A device of the CDDM type is formed across the annulus formed between (2) and (3).

In the embodiment shown it can be seen that the arrangement of the apertures is different to that in FIG. 1, resulting in a different mixing regime.

Further mixing occurs as a consequence of flow through the annuli formed between drum (1) and cage (2), between cage (2) and cage (3) and between cage (3) and sleeve (4). A particular advantage of this configuration is that the number of regions of high shear within the mixer can be increased. This enables the pressure to be reduced while maintaining the same degree of mixing.

### Example 3

### Fixed Drum and Sleeve, Rotating Inner Cage and Outer Cage

FIG. 3 shows a three part assembly comprising an inner drum (1) with a plain surface, an inner cage (2) and an outer cage (3) which are joined to form a single part (2,3) and an outer sleeve (4) with plain bore. The parts are dimensioned and assembled to be concentric with respect to each other. The configuration shown in the FIG. 3 and described in this Example 3 is not an embodiment of the invention as claimed.

In use, drum (1) and sleeve (4) remain static, and the cage (2,3) rotates.

Dispersive mixing occurs as a consequence of flow through the annulus formed between drum (1) and cage (2), and between cage (3) and sleeve (4). In the embodiment shown, flow from the apertures in cage (2) to cage (3) is restricted to a relatively narrow opening due to the relative position of the apertures. However, as only elements (2) and (3) are provided with apertures and both the drum (1) and sleeve (2) have smooth confronting surfaces there is no region of CTM-like distributive mixing in this configuration. Consequently this example is not an embodiment of the present invention.

### Example 4

### Fixed Drum, Inner Cage and Sleeve, Rotating Outer Cage

FIG. 4 shows a three part assembly comprising an inner drum (1) with cavities provided in its surface by means of cage (2) being fixedly attached to it, a cage (3) and an outer sleeve (4) with cavities (7) in its surface (in this embodiment the cavities are shown as if machined, which is a less preferred embodiment). The three parts are dimensioned and assembled to be concentric with respect to each other.

In use, drum (1), cage (2) and sleeve (4) remain static, and the cage (3) rotates.

Mixing occurs as a consequence of flow through the pathways defined by the cavities (7) defined by the sleeve (4), cage (2) and cage (3). The provision of the cavities in both confronting surfaces allows for a very broad variation in the shear conditions within the mixer.

In the schematic embodiment shown, the cage (3) is shown as displaced to the right. In use, such displacement of an element of the mixer enables the geometry of the mixer to be changed from CDDM-like to CTM-like. If the cage is displaced far enough then the regions of high extensional flow may be lost and the mixer will fall outside of the claims as there will be no CDDM feature present.

### Example 5

### Fixed Inner Stepped Drum and Outer Stepped Sleeve, Fixed Outer Cage, Rotating Inner Stepped Cage

FIG. 5 shows a mixer assembly comprising a stepped cage (2, 2a, 2b) which has an axial section profile formed from rings of increasing radial section in the direction of bulk flow, and which is sited between an inner stepped drum (1) with a surface profile which closely conforms to the inner surface of the stepped cage, and an outer stepped sleeve (4) with a surface profile which closely conforms to the outer surface of the stepped cage. Ports (5,6) are provided for the ingress and egress of the process stream. In the embodiment shown port (6) is the inlet and port (5) the outlet. In part the cavities in the outer confronting surfaces are formed by a fixed cage (3). In the alternative, they can be, for example, machined into the surface, as at (7).

Mixing occurs by the flow of materials between apertures and through the annuli formed between the confronting surfaces and the surfaces of the stepped cage.

In use the spacing on either side of the radial part of the cage (2a) is set to the desired value by axial displacement of the cage (2, 2a, 2b) and the drum (1) relative to the sleeve (4). Mixing also occurs as the process stream flows though this narrow spacing. Typically the spacing on either side of the region (2a) will be less than the spacing on either side of the regions (2) and (2b) of the cage. This is particularly advantageous if the components of the apparatus will expand during use as the spacing at (2a) can be modified to compensate whereas the spacing at (2) and (2b) cannot be. Thus, the narrowest space for extensional flow is arranged to be in the region (2b). In practice, a mixer would not have a single step as shown in FIG. 5, but a plurality of steps.

FIG. 5 also shows a mixer which has different configurations in different regions. Thus, the wider diameter portion of the mixer is configured like a CDDM, while the narrower portion is configured like a CTM. As will be appreciated, for any given rotation speed the relative rates of movement of the corresponding confronting surfaces and cage surfaces in the region of cage part (2) will be higher than those in the region of cage part (2b), due to the increased radius.

1. A distributive and dispersive mixing apparatus of the CDDM type comprising two confronting surfaces (1, 4) and at least one cage-like member (2,3) disposed between the confronting surfaces (1, 4) said cage-like member (2,3) defining passages for fluid flow adjacent at least one of the confronting surfaces (1, 4) CHARACTERISED IN THAT at least one of the at least two confronting surfaces (1, 4) is smooth, and the or at least one cage-like member (2,3) is driven by a motor to perform a rotation relative to at least one of the confronting surfaces (1, 4) and/or at least one other cage-like member (2,3), and ports (5, 6) are provided for ingress and egress such that the bulk fluid flow within the mixing apparatus is in the plane of the surface of the or at least one cage-like member (2,3).

2. A mixing apparatus according to claim 1, wherein at least one of the at least two confronting surfaces (1, 4) is provided with cavities.

3. A mixing apparatus according to claim 1, wherein the confronting surfaces (1, 4) can be rotated relative to each other.

4. A mixing apparatus according claim 1, which comprises at least two of said cage-like members (2,3).

5. A mixing apparatus according to claim 4, wherein said at least two cage-like members (2,3) can be rotated relative to each other.

6. A mixing apparatus according to claim 1, wherein at least a portion of the confronting surfaces (1, 4) are cylindrical and the, or each, respective portion of the cage-like member (2,3) is generally tubular.

7. A mixing apparatus according to claim 1, wherein at least a portion of the confronting surfaces (1, 4) are circular and the, or each, respective portion of the cage-like member (2,3) is generally disk-shaped.

8. A mixing apparatus according to claim 1, wherein at least a portion of the confronting surfaces (1, 4) are frusto-conical and the, or each, respective portion of the cage-like member (2,3) is generally frusto-conical.

9. A mixing apparatus according to claim 1, wherein at least one of the confronting surfaces (1, 4) is stepped.

10. A mixing apparatus according to claim 1, wherein at least one of the surfaces of a cage-like member (2,3) is stepped.

11. A mixing apparatus according to claim 1, wherein the normal separation of the confronting surfaces (1, 4) varies in the direction of bulk flow.

12. A mixing apparatus according to claim 1, wherein the normal separation of at least one confronting surfaces (1, 4) and an adjacent cage like member (2,3) varies in the direction of bulk flow.

13. Use of mixing apparatus according to claim 1 for the treatment of a liquid, emulsion gel.
